(19) United States
(12) Patent Application Publication
(10) Pub. No.: US 2008/0056957 A1
(43) Pub. Date: Mar. 6, 2008

(54) SEGMENTED REACTION BLOCKS FOR SUPPORTING VIALS OF DIFFERENT SIZES FOR CHEMICAL SYNTHESIS ON A HOT PLATE STIRRER

(75) Inventor: Howard Hayman, Vineland, NJ (US)

Correspondence Address: FITZPATRICK CELLA HARPER & SCINTO, 30 ROCKEFELLER PLAZA, NEW YORK, NY, 10112, US

(73) Assignee: CHEMGLASS, INC., VINELAND, NJ (US)

(21) Appl. No.: 11/469,560

(22) Filed: Sep. 1, 2006

(51) Int. Cl. B01L 9/00

(52) U.S. Cl. 422/104

(57) ABSTRACT

A laboratory device for mounting vials of different volumes upon a laboratory hot plate stirrer that is made of a heat conducting material that does not interfere with a magnetic flux. A base holder with an upper surface and a circumferential upper lip engage one or more single-shaped reaction blocks. The base holder lower surface is adapted to engage upon and around a hot plate surface in an intended use. Each reaction block has a set of vertically extending bores to accept a particular diameter of vial and of a height about half the height of the vial to be accepted. Each block is interchangeable with another at any location on the base holder. Drains within each bore communicate with a drain through the base holder.

### BACKGROUND OF THE INVENTION

1. Field of the Invention

The present invention relates to a mantle block base holder and interchangeable reaction block wedges capable of accommodating sets of differently sized glass reaction tubes or vials, typically from 4 ml to 40 ml in volume, upon a magnetic stirrer integrated with a hot plate.

2. Brief Description of the Prior Art

In the field of organic chemistry it is often desirable to perform a chemical reaction under precise heat transfer and stirring conditions. Known laboratory stirrers suited for use with the present invention include the Opti CHEM Model CG-1993-01 hot plate stirrer from Chemglass of Vineland N.J.; the Ikamag RET, RCT and RH Basic magnetic stirrers from IKA of Germany; and the Heidolph MR3000 series of magnetic stirrers. Typically such hotplates are round and have a diameter of 135 mm although some hotplate stirrers, such as the Snijders Model 34532, from Snijders of the Netherlands, employ a top plate diameter of 194 mm. The present invention is illustrated by a preferred embodiment that accommodates a hotplate of about 5.2 inches in diameter, but the principles apply to any size hotplate.

The use of a reaction block to hold reaction vessels upon a surface of a magnetic stirrer is known. Landsburger (U.S. Pat. No. 3,356,316) illustrates a vinyl block with a plurality of test tube holders.

Where both stirring and heating are desired, prior art heat conduction blocks have been constructed of various configurations and materials. Kindmann (U.S. Pat. No. 5,529,391) illustrates thermoelectric elements and metal cooling fins attached to each of four sides of a square, aluminum heat conducting block, that then is positioned over a plurality of individual magnetic stirring devices. Ladlow et al. (U.S. Pat. No. 6,905,656) illustrates a solid adapter block with a plurality sockets to arrange test tubes outside of the periphery of a round hot plate stirrer, wherein the adapter block is said to be made of any chemically resistant material, such as PTFE, aluminum or stainless steel. Radleys Discovery Tech Ltd., of the United Kingdom, sells a StarFish, modular heating and stirring work station that employs a flat base plate that can support either a round MonoBlock or segmented PolyBlocks as reaction blocks for supporting various sizes of vials or other laboratory glassware upon a round hot plate stirrer.

The present device is advantageous over such known devices in that it comprises a thin lower circumferential wall to engage about a hot plate element and a thin upper circumferential wall surrounding a thin horizontal surface that supports one or more interchangeable reaction block wedges safely and snugly, all to enhance safety and allow excellent heat transfer. Each wedge is sized to accept a particular standard vial size, and has a plurality of bores of a depth calculated to snugly surround approximately the lower half of the supported vial size.

### SUMMARY OF THE INVENTION

Hot plate stirrers to generate a magnetic field under a hotplate 68 mm (5.2 inches) in diameter and various sizes of vials are easily accommodated by this device for effective rotating the magnetic stir bars in each vial. The mantle block base holder of the assembly is machined aluminum and is configured with an upper circular surface and circumferential wall to engage and align up to four reaction block wedges and a lower surface and circumferential wall to engage upon and around the circumference of a supporting hot plate. Each reaction block wedge is a quarter circle in plan view, has a plurality of spaced vertical bores for a particular vial size and a thickness that permits about one half of the height of the particular vial size to fit snugly within the bore. These engagements create a safe and effective heat transfer for the liquid samples within each vial and do not to interfere with the magnetic field, being generated from below the hot plate surface.

At the bottom of each bore in a wedge a novel drain bore extends through to the lower surface of the wedge, and the base holder likewise has at least one novel drain bore extending between the upper surface of the base holder and the lower surface of the base holder. These drain bores cooperate as a system to drain off any fluid that might accumulate in either a bore or on the upper surface of the base holder. This drainage feature eliminates liquid flash points or splatter from liquids pools unknowingly accumulated in either a bore or under a wedge and also facilitates clean up and drying of the wedge and the base holder.

Sets of various common size vials, typically ranging in volume from 4 ml to 40 ml, are maintained so that at least the centerline of each vial is maintained inside of the outer diameter of the supporting hot plate, typically 135 mm, and thereby the fluid in each vial is more effectively mixed through a smooth and continuous rotation of magnetic stir bars. Each individual wedge also includes a standard threaded hole or thermowell, roughly centrally located in the upper surface, to accommodate a standard digital contact thermometer, other temperature sensor, or even a lifting rod to facilitate the entire wedge being quickly and securely removed from, or placed upon, the upper surface of the base holder.

The top of the mantle block base holder preferably comprises a horizontal, circular plate of a thin wall thickness with a circumferential wall or lip of a thin wall thickness that acts to loosely engage against part of the circular side surface of up to four wedge shaped reaction blocks placed on the circular plate. The bottom of the mantle block base holder preferably further comprises a circumferential wall or lip of a thin wall thickness that acts to loosely engage the circular side wall of a supporting hot plate. The bore diameter in each wedge is configured to snugly accept a particular vial diameter, and the vertical dimension of each bore is configured to be approximately one-half of the vertical dimension of the vial.

This combination of structure ensures that the circular plate portion of the base holder will be in good heat transfer contact with both the hotplate and each supported wedge and that each vial in a wedge will be within the most effective portion of the magnetic flux being generated by the magnetic stirring mechanism.

This combination of structure also greatly ensures safety, in several respects. The heat transfer into a fluid sample of a typically half-full vial will be optimized by avoiding direct contact of the wedge bore with the vial wall portion that is above the liquid level. The chance of a boil over of that sample out of the vial also thereby is minimized. Any fluid boiled out or spilled from a vial or any fluid that had pooled either around a vial or on the upper surface of the base holder will be effectively drained away from the hotplate. Each wedge can be easily placed and removed vertically from the base holder by a rod connected to the thermowell. Each placed wedge is held securely and cannot inadvertently be knocked horizontally off the base holder. The base holder cannot inadvertently be knocked horizontally off the heating element.

The base holder and each wedge are cast, forged or machined from aluminum, but alternatively might be made of any non-ferrous metal, stainless steel, ceramic or other high heat transfer coefficient material that will not interfere with a magnetic flux. The preferred embodiment base holder has a horizontal surface and circumferential lip that are circular in shape, to accommodate the common, round hot plate stirrers, as discussed above, but polygonal, rectangular, square or any other particular lower surface and lip shape is contemplated.

The preferred embodiment has single-shaped reaction blocks which are four, quarter circle wedges that fit within a circular circumferential wall so as to be supported snugly upon the circular plate portion of the base holder. Polygonal, square or any other particular upper surface and lip shape that will snugly accommodate a plurality of single-shaped, reaction blocks in other than a wedge shape is contemplated. A single shape and horizontal size of each reaction block is a feature of the invention, with variable vertical heights to a particular reaction block being a further feature of the invention. Standard vials of either a 20 ml, 30 ml or 40 ml capacity have a common outer diameter, (28 mm), and varying heights (60 mm, 73 mm, and 98 mm) so that wedges for such vials according to the present invention can have a common shape and bores of a common diameter and only different heights to effectively heat and stir the typical half-full samples in each sized vial.

Hence, it is a first object of the present invention to provide a circular plate portion of a base holder that will both be in good heat transfer contact with both a hotplate and each supported wedge while ensuring that each vial in a wedge will be within the most effective portion of the magnetic flux being generated by the magnetic stirring mechanism.

It is a second object of the present invention to provide a combination of structure also greatly ensures safety, in several respects. The heat transfer into a fluid sample of a typically half-full vial is optimized by avoiding direct contact of the wedge bore with the vial wall portion that is above the liquid. Any fluid pooled either around a vial or on the upper surface of the base holder will be effectively drained away from the hotplate. Each wedge can be easily placed and removed vertically from the base holder. Each placed wedge cannot inadvertently be knocked off the base holder. The base holder cannot inadvertently be knocked off the heating element.

It is a third object of the present invention to provide a single-shaped reaction block, so that a plurality of them can interchangeably and snugly fit within a circumferential wall when supported upon a horizontal portion of a base holder.

It is a fourth object of the present invention to provide a single shape and horizontal size of each reaction block that may have bores of a common diameter but with different heights to effectively heat and stir the typical half-full samples in vial sizes of a common diameter but with different heights.

It is a fifth object of the present invention to provide a round mantle block of aluminum and interchangeable wedge-shaped reaction blocks of aluminum that are color coded as to the size of the vial that each block is intended to hold.

### BRIEF DESCRIPTION OF THE DRAWINGS

A preferred embodiment of the invention is described in detail below, with reference to the accompanying drawings, wherein:

FIG. 1 is a right front perspective, explosion view of a mantle block base holder with four, interchangeable reaction block wedges according to a preferred embodiment of my invention, in an intended use upon a laboratory magnetic stirrer hot plate, that is shown in dotted line;

FIG. 2 is a top plan view of the base holder of FIG. 1;

FIG. 3 is a bottom plan view of the base holder of FIG. 1;

FIG. 4 is a left side elevation view of the base holder of FIG. 1, the right side being a mirror image thereof;

FIG. 5 is a vertical cross-section view of the base holder of FIG. 1, taken along a front to back diameter; with a superposed reaction block wedge holding a vial, and shown in an intended use upon a top surface of a laboratory magnetic stirrer and hotplate, that is shown in dotted line.

FIG. 6 is a top plan view of a first reaction block wedge with bores able to accommodate 4 ml vials.

FIG. 7 is a top plan view of a second reaction block wedge with bores able to accommodate either 20 ml, 30 ml or 40 ml vials.

FIG. 8 is a vertical cross-section detail view of a portion of a reaction block wedge able to accommodate a 20 ml vial.

FIG. 9 is a vertical cross-section detail view of a portion of a reaction block wedge able to accommodate a 30 ml vial.

FIG. 10 is a vertical cross-section detail view of a portion of a reaction block wedge able to accommodate a 40 ml vial.

FIG. 11 is a top plan view of a third reaction block wedge with bores able to accommodate 16 ml vials.

FIG. 12 is a top plan view of a fourth reaction block wedge with bores able to accommodate 8 ml vials.

### DESCRIPTION OF THE PREFERRED EMBODIMENT

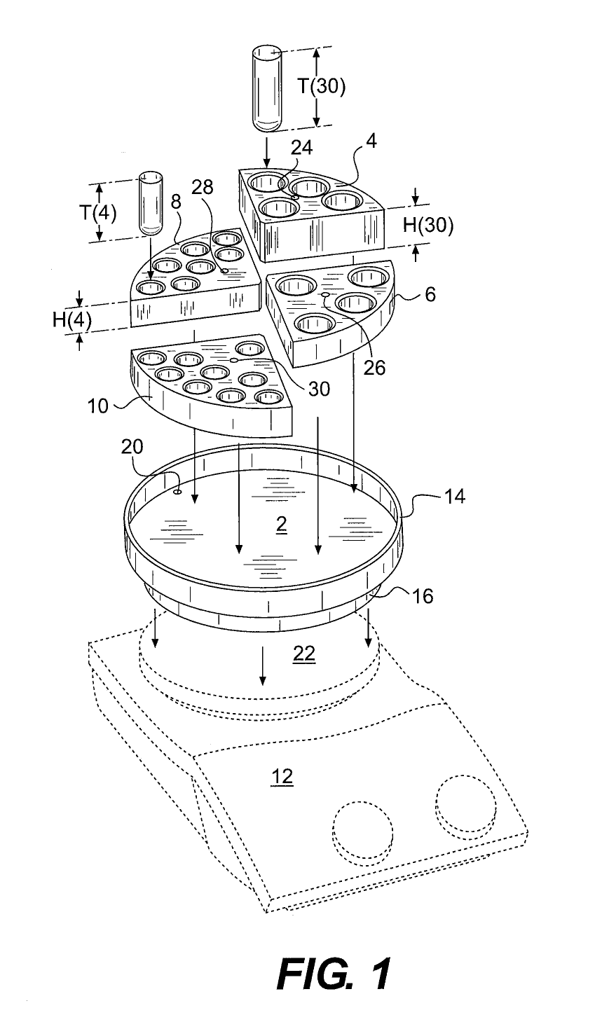

The preferred embodiment illustrated in FIG. 1 comprises a mantle block base holder of machined aluminum that is configured with an upper circular surface 2 and a circumferential upper lip or wall 14 to engage and align up to four reaction block wedges 4, 6, 8, and 10 and a lower surface and circumferential lower lip or wall 16 adapted to engage upon and around the circumference of a supporting hot plate 22 of a hotplate/magnetic stirrer 12, shown in dotted line. The upper surface 2 includes a drain bore 20 to allow liquids to drain down and away from the hot plate surface 22.

Each reaction block wedge is a quarter circle in plan view, has a plurality of spaced vertical bores for a particular vial size and a thickness that permits about one half of the height of the particular vial size to fit snugly within the bore. The radius of each wedge is about 3.125 inches. The diameter of the upper surface 2 inside the upper lip 14 is about 6.28 inches. The diameter of the lower surface 18 inside the lower lip 16 is about 5.35 inches. A bore 129 inches by 0.75 inches deep provided as the thermowell 24, 26, 28, 30 is located somewhat centrally in the top surface of the respective wedges 4, 6, 8, and 10.

The centerline of each bore is on a circle with a diameter that is less than the diameter of the hotplate 22. It has been found that the magnetic stirrers in a vial do not rotate smoothly when a vial centerline is positioned at or outside the outer diameter of the hot plate. The locus of centerlines for the outer set of bores in a wedge range from a radius of 2.75 inches for the 4 ml wedge 8 to a radius of about 2.5 inches for the 40 ml wedge 4. The diameter of the hotplate to be used is less than 5.35 inches.

A representative 30 ml vial of height T(30) is illustrated above a bore in wedge 4 that has a vertical thickness H(30). A representative 4 ml vial of height T(4) is illustrated above a bore in wedge 8 that has a vertical thickness H(4). The ratio of T/H is greater than about 2. These relationships create a safe and effective heat transfer for the typical half-full liquid samples within each vial. A direct contact of the wedge bore with the vial wall portion that is typically above the liquid level is to be avoided. Boil over of a sample out of the vial is minimized by not contact heating the glass portion that is not conducting heat into an adjacent liquid. The base holder and wedge are of aluminum and do not to interfere with the magnetic field, being generated from below the hot plate surface.

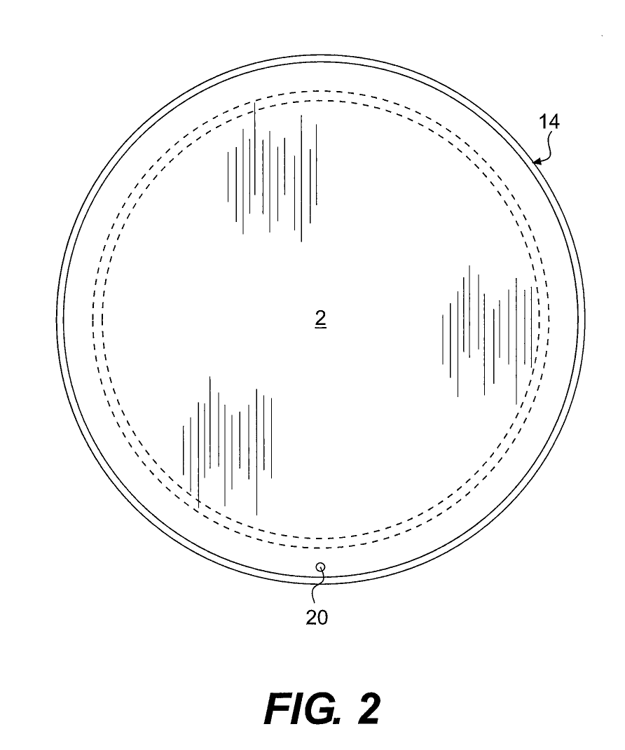

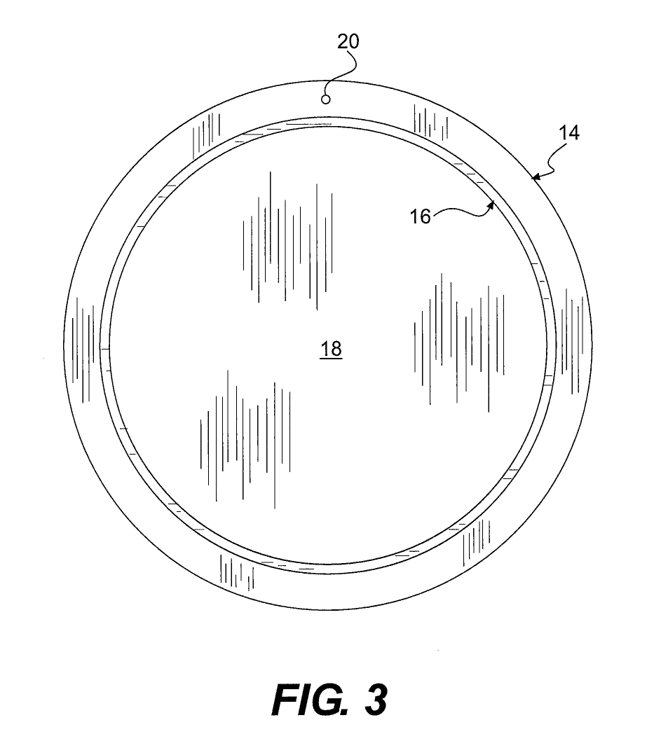

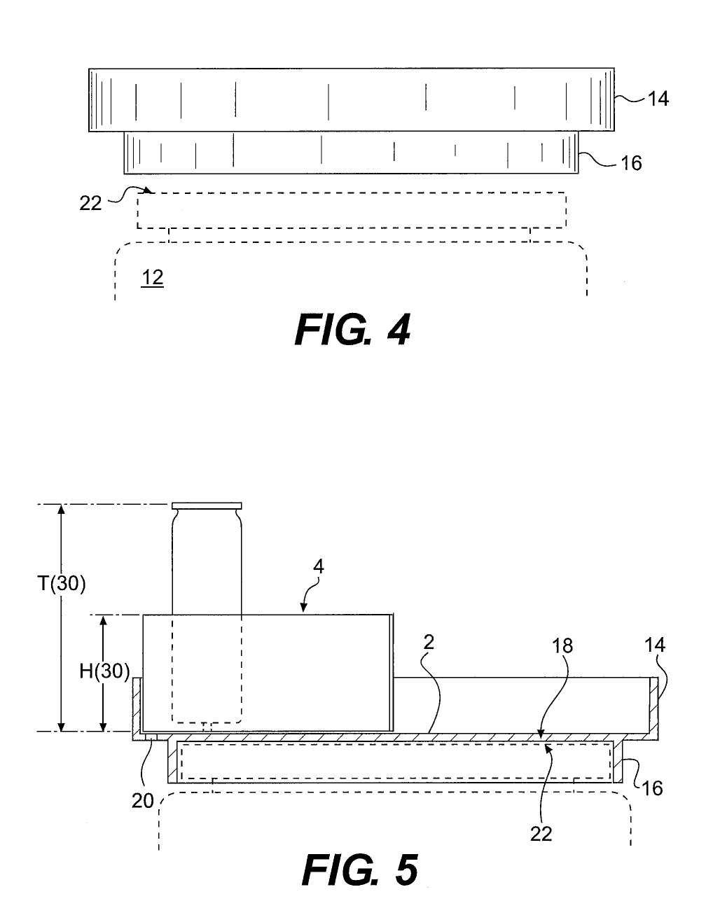

FIGS. 2 and 3 show top and bottom plan views of the base holder. The upper surface 2 includes a drain bore 20 in an annular space near the upper lip 14, and outside the outer surface of the lower lip 16 in order to allow any accumulated liquids to drain through to the bottom surface 18 and down to a location away from the hot plate 22. The upper lip 14 is sized to be about 0.75 inches high and 6.28 inches in diameter at its inner surface. The lower lip 16 is sized to be about 0.5 inches high and 5.350 inches in diameter at its inner surface, or slightly greater in diameter than the 5.2 inch hotplate diameter of a preferred device, the Opti CHEM Model CG-1993-01 hot plate stirrer from Chemglass of Vineland N.J. The thin wall thicknesses of the horizontal surface 2, the upper lip 14 and the lower lip 16 quickly conducts heat radially inward and upward towards the mass of the wedge elements 4, 6, 8, 10. The base holder and the individual reaction blocks overall are configured to have a minimized amount of mass and thermal capacity, in order to quickly respond to changes in temperature being required by the controller (not illustrated) which dictates the temperature at the hot plate surface 22.

FIG. 5 further illustrates an intended use of the assembled reaction block upon a top surface of a conventional laboratory magnetic stirrer and hotplate, 12 FIG. 5 is a vertical cross-section view of the base holder of FIG. 1, taken along a front to back diameter. The superposed reaction block wedge 4 is shown holding a 30 ml capacity vial of a height T (30) that is about 2.5 inches, while the wedge has a height H (30) of about 1.25 inches. FIG. 5 shows an intended use, with the lower surface 18 resting upon a top surface 22 of a laboratory magnetic stirrer and hot plate, that is shown in dotted line. The flat lower surface 18 and lower lip 16 are of a thin wall thickness. The inside of lip 16 is 5.35 inches in diameter to engage over and around the flat area but also slightly outside the edge of hot plate upper surface 22. In this manner, the base holder and superposed reaction blocks will remain fixed and located well within the magnetic field of the laboratory stirrer, and the hot surface 22 will be shielded from an inadvertent contact with the hands of a lab technician.

Preferred same-shaped reaction blocks in a four piece wedge configuration are shown in FIGS. 1, 6, 7, 11 and 12. All of the wedges have the same dimensions in a plan view, and any four can fit together to make a circular combination with a diameter of slightly less than 6.28 inches and each wedge is interchangeable at any of four locations inside of the lip 14 of the base holder.

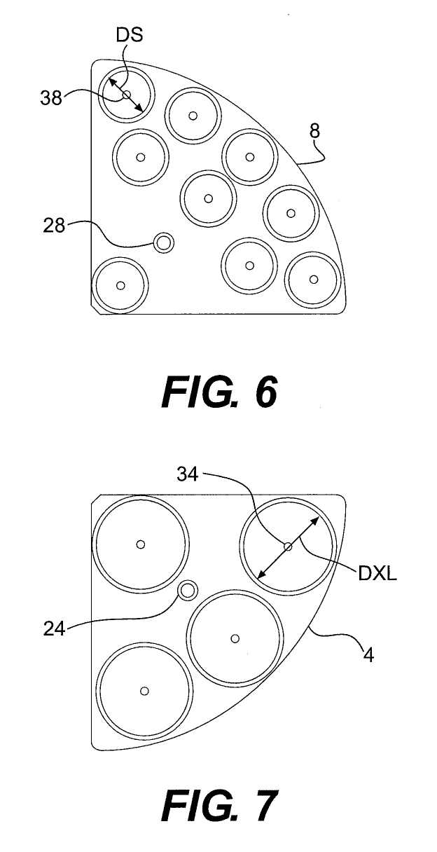

FIG. 6 is a top plan view of a first reaction block wedge 8 of anodized, 6061 aluminum with 8 bores able to accommodate 4 ml vials. The bore size DS is about 0.597 inches in diameter and drilled 0.75 inches deep into a wedge with a height of 0.813 inches. Each bore has a central drain bore of about 0.125 inches. A thermowell about 0.129 inches in diameter is drilled 0.75 inches deep.

FIG. 7 is a top plan view of a second reaction block wedge 4 of anodized, 6061 aluminum with 4 bores able to accommodate either 20 ml, 30 ml, or 40 ml vials. The bore size DXL is about 1.1 inches in diameter for all three versions. Each thermowell 24 is about 0.129 inches in diameter. In this manner the same plan view dimensions and bore array can be used to make interchangeable reaction block wedges for at least three different vial sizes, simply by changing the vertical height of each wedge.

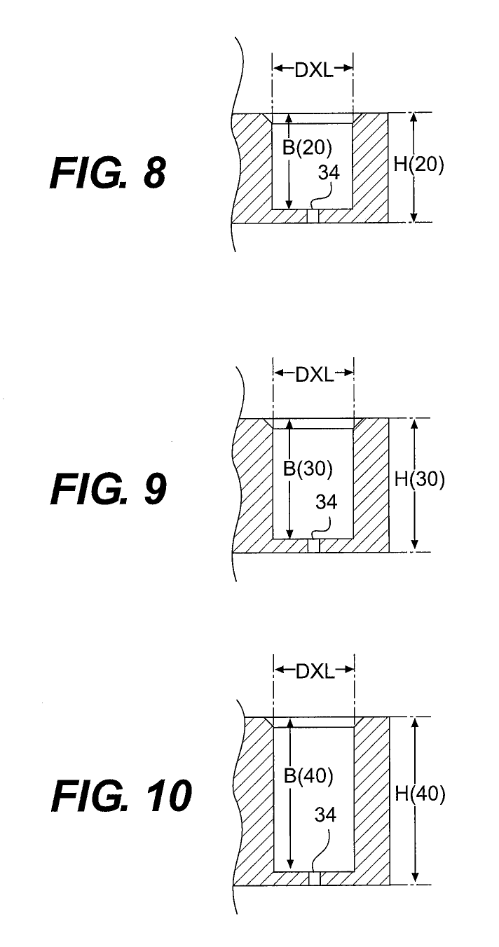

As shown in the detail partial section view of FIG. 8, for a 20 ml version of wedge 4 the bore and thermowell 24 are drilled to a depth B(20) that is 0.938 inches deep into a wedge of black anodized aluminum with a height H(30) of 1.0 inches. As shown in the detail partial section view of FIG. 9, for a 30 ml version the bore and thermowell 24 are drilled to a depth B(30) that is 1.18 inches deep into a wedge of green anodized aluminum with a height H(30) of 1.25 inches. As shown in the detail partial section view of FIG. 10, for a 40 ml version the bore and thermowell 24 are drilled to a depth B(40) that is 1.68 inches deep into a wedge of orange anodized aluminum with a height H (40) of 1.75 inches. Each bore has a central drain bore 34 of about 0.125 inches.

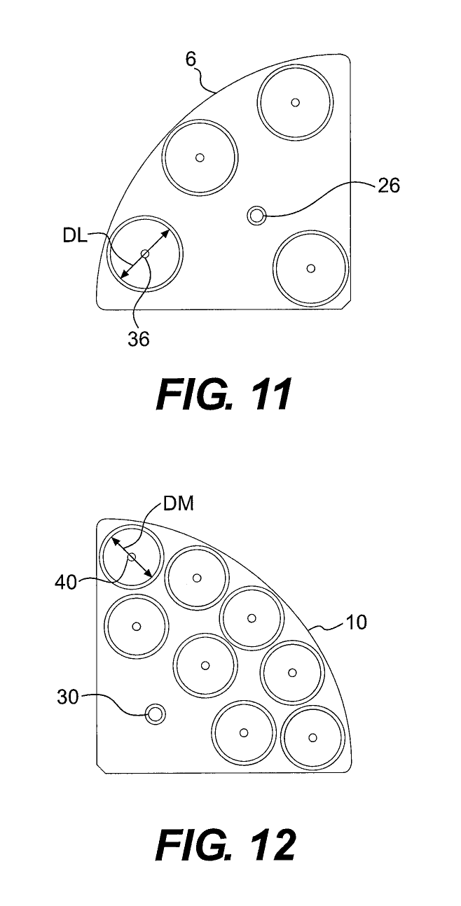

FIG. 11 is a top plan view of a third reaction block wedge 6 of red anodized, 6061 aluminum with 4 bores able to accommodate 16 ml vials. The bore size DL is about 0.85 inches in diameter and drilled 1.25 inches deep into a wedge with a height of 1.313 inches. Each bore has a central drain bore of about 0.125 inches. A thermowell 26 about 0.129 inches in diameter is drilled 1.25 inches deep.

FIG. 12 is a top plan view of a fourth reaction block wedge 10 of blue anodized, 6061 aluminum with 8 bores able to accommodate 8 ml vials. The bore size DM is about 0.70 inches in diameter and drilled 1.00 inches deep into a wedge with a height of 1.063 inches. Each bore has a central drain bore of about 0.125 inches. A thermowell 30 about 0.129 inches in diameter is drilled 1.00 inches deep.

While preferred embodiments have been shown and described in order to satisfy the requirements of 35 USC § 112, the invention is to be defined solely by the scope of the appended claims

I claim:

1. A laboratory device for mounting vials of different volumes upon a laboratory hot plate stirrer, essentially comprising a base holder with an upper surface and a lower surface and at least one reaction block, both being made of a heat conducting material that does not interfere with a magnetic flux, wherein the base holder lower surface further comprises a circumferential upper lip and is adapted to engage upon and around a hot plate surface in an intended use and the upper surface further comprises a circumferential lower lip and is adapted to support and engage one or more single-shaped reaction blocks placed upon said upper surface, wherein each reaction block has at least one vertically extending bore to accept a particular diameter of vial and is interchangeable with another reaction block at any location on the upper surface of the base holder.

2. A laboratory device according to claim 1, wherein the heat conducting material of the base holder that does not interfere with a magnetic flux material comprises a non-ferrous metal and an air space separates the lower lip from a side of a hot plate in its intended use.

3. A laboratory device according to claim 2, wherein the non-ferrous metal of the base holder is aluminum, the upper surface of the base holder is circular and extends horizontally with a circumferential wall as an upper lip at its outer periphery, and each single-shaped reaction block is of the same wedge configuration in horizontal plan view but with a particular vertical height.

4. A laboratory device according to claim 3, wherein the material of each wedge shaped reaction block is aluminum, the lower surface of the base holder is circular, extends horizontally with a circumferential wall as a lower lip and is of a diameter greater than the diameter of a supporting hotplate in an intended use.

5. A laboratory device according to claim 1, wherein the upper surface of each same-shaped reaction block has a plurality of vertical bores that are of a size to accommodate a particular size of vial and each bore extends into the reaction block to a depth that is approximately one half of the vertical height of the vial size to be accommodated, in an intended use.

6. A laboratory device according to claim 1, wherein the upper surface of the base holder is circular and extends horizontally with a circumferential wall as an upper lip at its outer periphery, and is adapted to accept more than one single-shaped reaction block of the same wedge configuration in horizontal plan view.

7. A laboratory device according to claim 6, wherein the upper surface of each wedge-shaped reaction block has a plurality of vertical bores that are round and of the same diameter to accommodate a particular size of vial, and the vertical height of each wedge-shaped reaction block is sufficient to allow each bore to extend vertically to a depth that is approximately one half of the vertical height of the vial size to be accommodated, in an intended use, and still define a thin wall at the bottom of each bore that includes a drain bore.

8. A laboratory device according to claim 6, wherein the upper surface of the base holder is adapted to accept and support four single-shaped reaction blocks of the same wedge configuration in horizontal plan view and includes a drain bore between the upper and lower surfaces.

9. A laboratory device according to claim 8, wherein the vertical height of each wedge-shaped reaction block is sufficient to allow each bore to extend vertically to a depth that is approximately one half of the vertical height of the vial size to be accommodated, in an intended use, and still define a thin wall at the bottom of each bore that includes a drain bore that communicates with a drain bore between the upper and lower surfaces and which is located inside the upper lip and outside the lower lip.

10. A laboratory device according to claim 1, wherein the upper surface of each same-shaped reaction block has a vertical bore to accept a temperature measuring probe.

11. A laboratory device according to claim 1, wherein the upper and lower surfaces of the base holder are circular and define a thin wall therebetween, each same-shaped reaction block has a partial circular outer surface adapted to snugly engage against an inner surface of the upper lip and a plurality of vertical bores that are round and of the same diameter to accommodate a particular size of vial in an intended use, and the centerline of each bore is along a diameter that is smaller than the diameter of the lower lip.

12. A laboratory device according to claim 1, wherein each of the same-shaped reaction blocks are color coded as to the different size vial which is to be accommodated, in an intended use.
